(19) United States
(12) Patent Application Publication
(10) Pub. No.: US 2007/0175036 A1
(43) Pub. Date: Aug. 2, 2007

(54) Process and equipment to make elbows for draining rainwater

(76) Inventor: Roberto Minoletti, Domodossola (VB) (IT)

Correspondence Address: MICHAEL J. STRIKER, 103 EAST NECK ROAD, HUNTINGTON, NY, 11743, US

(21) Appl. No.: 11/570,180

(22) PCT Filed: Jul. 28, 2004
(86) PCT No.: PCT/IT04/00414

§ 371 Date: Dec. 7, 2006

(30) Foreign Application Priority Data
Jun. 17, 2004 (EP) MI2004AOO1221

(51) Int. Cl. B23P 17/00

(52) U.S. Cl. 29/890.149

(57) ABSTRACT

Installation for making elbows for draining rainwater, formed by execution of a series of external and internal welds on the superimposed edges of an assembled pair of elbow halves, causing said pair to slide around and along an arched bar between two projecting external and internal welding points, respectively connected to the first and second wires leading to a source of electric energy.

The invention concerns the elbows used on gutters to drain rainwater from roofs.

Commonly applied to this purpose are semi-cylindrical channelling means, generally of metal, known as gutters.

The gutters are fixed to the eaves to collect rain water which then passes into vertical pipes reaching down to the ground.

Special pipe fittings are required for joining gutters to the down pipes these fittings, or elbows, often varying in dimensions and positioning. The already well-known metal elbows usually consist of two longitudinal pieces bent and assembled by means fitted onto their edges.

The use of these elbows, which causes the rainwater to make a sharp change in direction, means that they are often subjected to varying degrees of stress, sometimes extremely severe.

In view of the amount of water they may have to carry, the main feature of these elbows consists in their capacity to withstand violent rain storms and high winds.

Although of a complex and costly structure, the manner in which elbows are usually assembled in order to fulfil their function does not necessarily ensure continuity and may even fail under adverse climatic conditions.

The above invention lessens these drawbacks, at the same time offering further advantages as will now be explained.

Subject of the invention is an installation for making elbows for rainwater drainage, the elbows being formed by a series of external and internal welds on the superimposed lengthwise edges of a pair of assembled elbow halves.

Assembly of the two elbow halves is done by fitting one of their ends into the circular groove of a head piece, here called an assembly head, said groove presenting elastic fixing means.

The external and internal welds are made by sliding the two assembled elbow halves along an arched bar, the radius of the arch corresponding to that of the elbow halves and its length to the maximum length of the elbow.

At the upper end of the bar is a head with two lateral protruding welding points, here called internal, extending along a geometrical welding axis XX, transversal to the lengthwise geometrical plane of symmetry of said arched bar, at a position in which contact with the inner surface of said pair of elbow halves can be maintained at their superimposed longitudinal edges.

Also along said welding axis XX are two lateral protruding welding points, here called external, worked by the pistons of dynamically operative cylinders.

The internal welding points are connected, through the arched bar and an elastic contact, to a first wire leading to a source of electric current.

The external welding points are connected, by elastic contacts, to the second wire leading to said source of electric current.

The installation comprises a mechanical shaft, rotated by an electric motor, along a geometrical axis YY substantially coinciding with the axis of the arched bar.

A plate is fixed to said shaft by two lateral arms, in which plate is a large hole fitted with means to receive and retain the other end of the pair of elbow halves when the assembly head- in which the first end of said pair of elbow halves is already fitted is positioned on a bracket lying substantially on the same horizontal geometrical plane as the YY axis of the mechanical shaft.

Also lying substantially on the vertical geometrical plane of the geometrical axis YY of the mechanical shaft and the welding axis XX, are the axes of two rollers for guiding the pair of elbow halves to be welded, these rollers translating on their geometrical plane, the upper roller being worked by the piston of a dynamically operative cylinder and the lower roller by cams mounted on the mechanical shaft.

To begin the first stage of the working cycle, a pedal to start the motor, placed on the front of the installation, is pressed to initiate movement of the mechanical shaft causing the pair of elbow halves to slide towards the rear of the installation, pulled by the plate to which the second end of the pair of elbow halves is fixed, guided by the upper and lower rollers which have simultaneously approached said pair of elbow halves

An electronic governor closes the electric circuit by moving the external welding points towards the internal welding points at programmed intervals, so as to weld together the pair of elbow halves which have been made to slide between said internal and external welding points.

On completion of the sliding movement, the assembly head is removed by hand from the pair of elbow halves after which the pedal is again pressed to carry out the second stage of what amounts to a substantially continuous welding process.

This stage comprises a reverse movement of the plate and therefore of the stabilized pair of elbow halves, closure of the electric circuit when the external welding points move towards the internal welding points and, at the end of the cycle, detachment of the upper and lower rollers from the elbow enabling it to be picked up.

The control unit can determine, as required, the length of the arc of movement of the mobile plate according to the length of the elbow halves to be welded.

The invention offers evident advantages.

Welding of the longitudinal edges of the elbow halves by means of internal and external electrodes not only ensures maximum resistance to violent stresses but also creates a functionally aesthetic appearance that might even be considered as decorative.

The almost entirely automated production process reduces labour costs while also making sure that sizes and shapes are constant, facilitating the work of installation and assuring uniformity of characteristics.

The elbows subject of the invention thus provide efficient and hardwearing pipe connections able to withstand the effects of time and weathering, but which can also offer aesthetically decorative features.

Characteristics and purposes of the invention will be made still clearer by the following example of its execution illustrated by diagrammatically drawn figures.

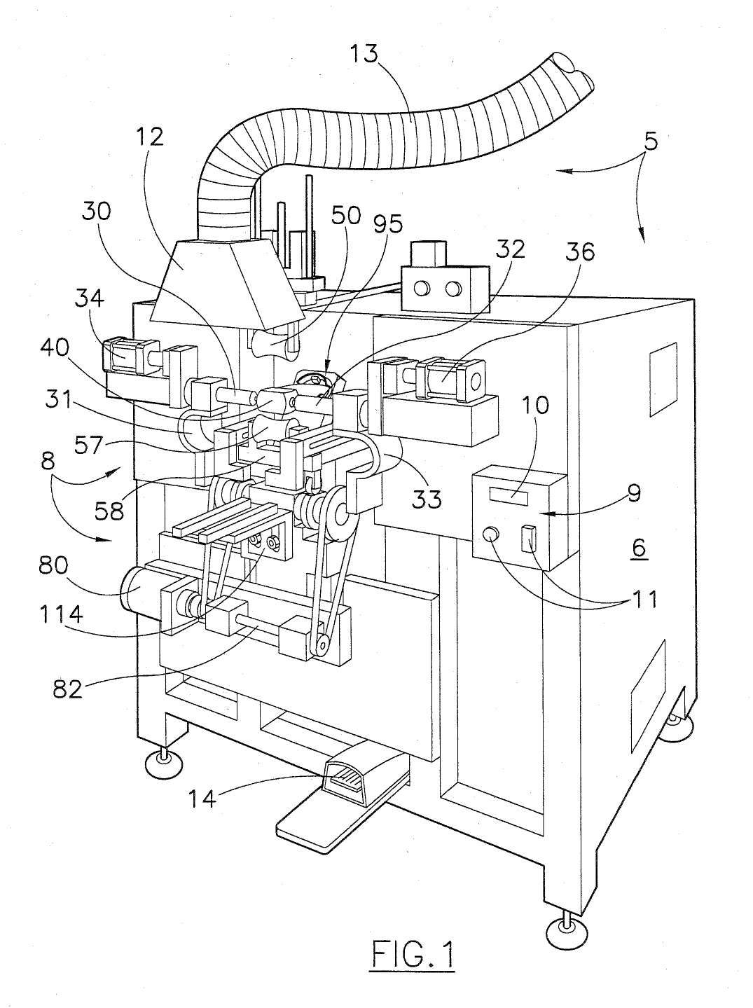

FIG. 1 Installation for the production of elbow joints by welding together two elbow halves, perspective view from the front.

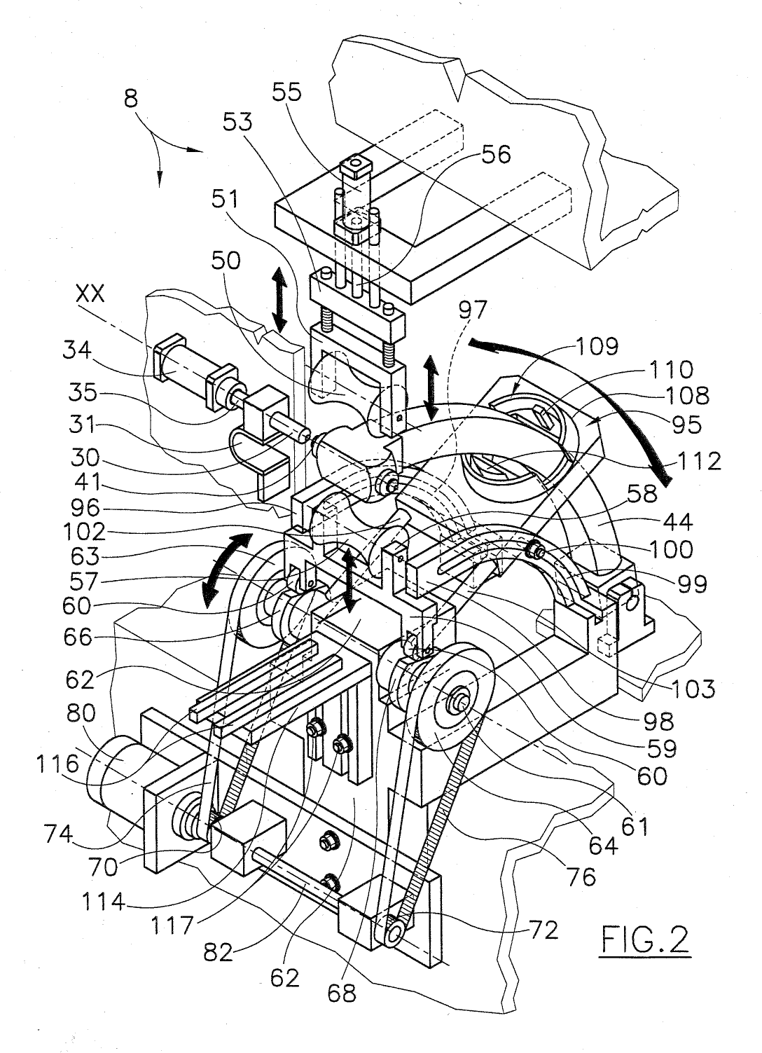

FIG. 2 The welding unit, front perspective.

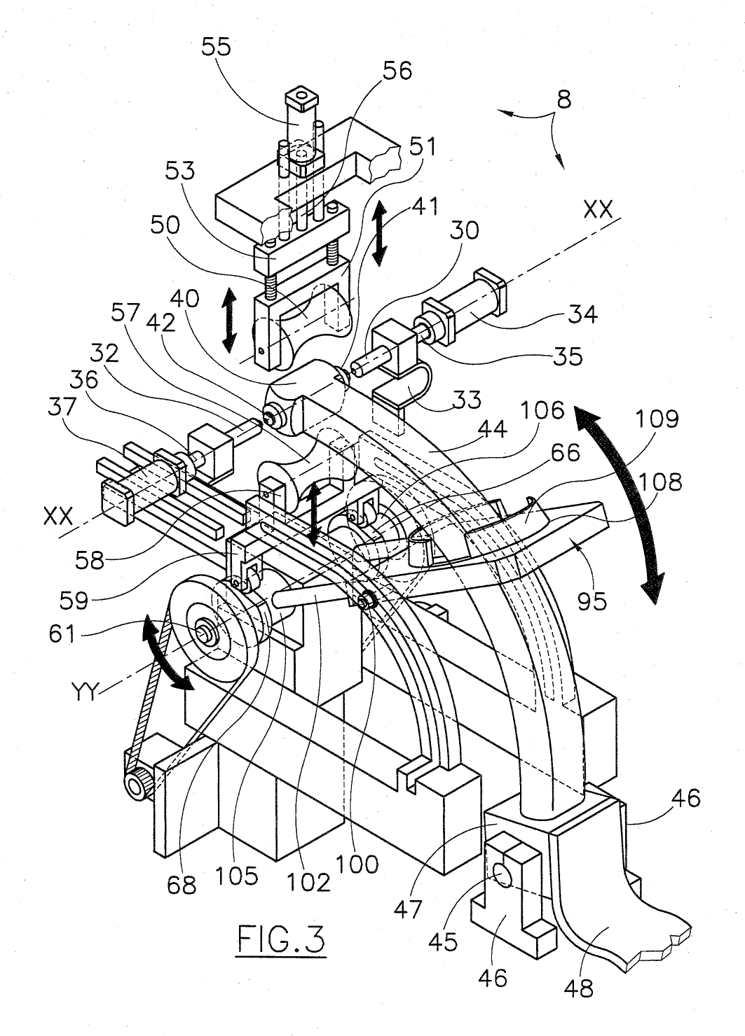

FIG. 3 The welding unit, rear perspective.

FIG. 4 A pair of elbow halves associated longitudinally by insertion of one of their ends in an assembly head, perspective.

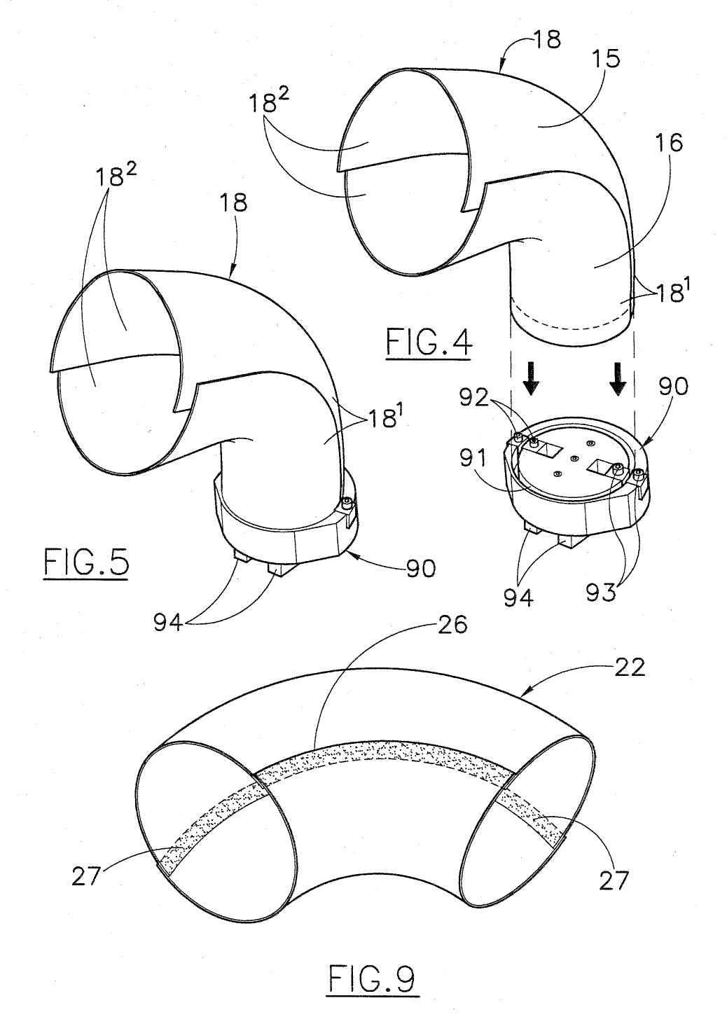

FIG. 5 The pair of elbow halves when fitted into the assembly head, perspective.

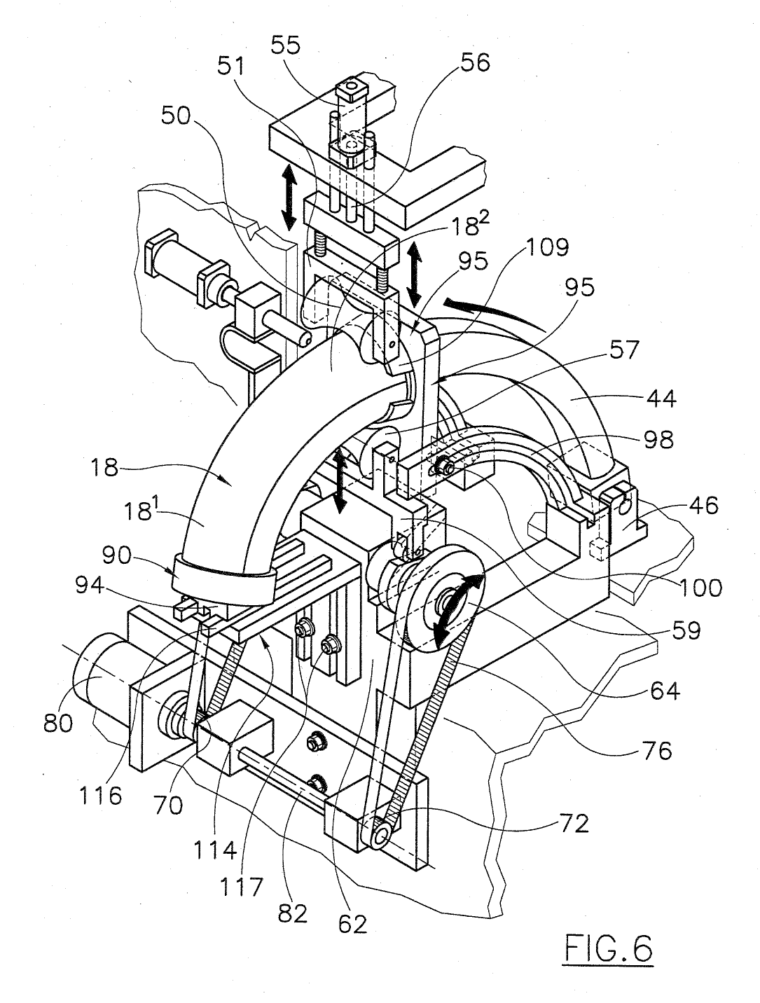

FIG. 6 The welding unit at the start of the production cycle, front perspective.

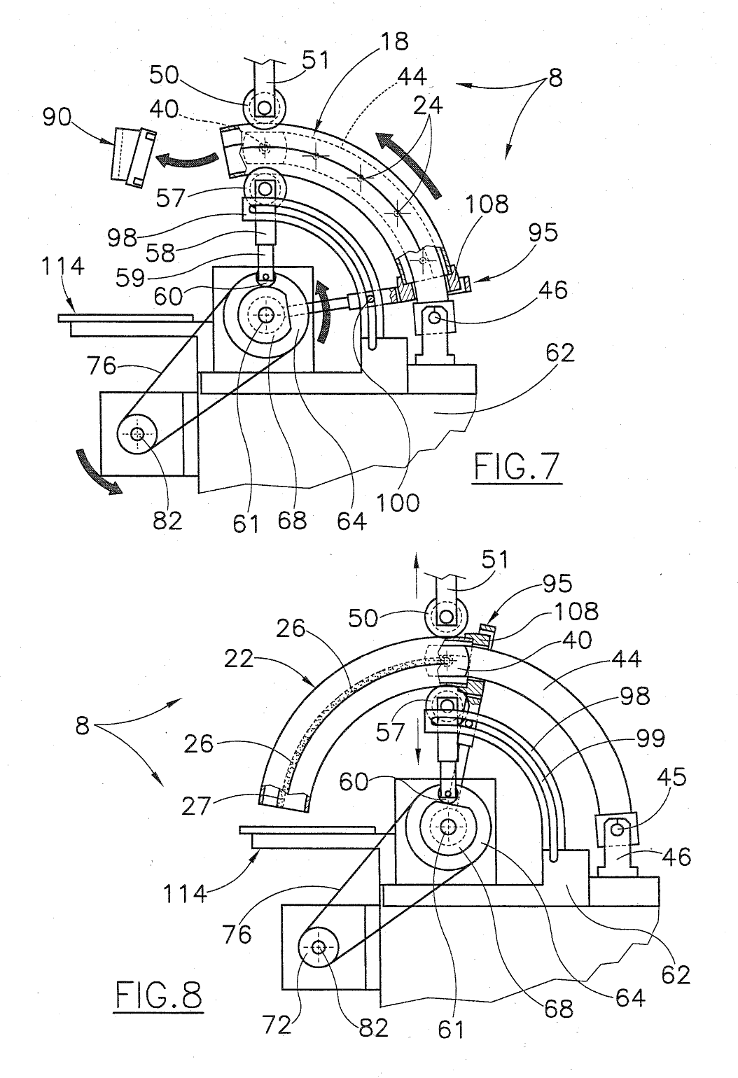

FIG. 7 The welding unit when several welds have been carried out to make an elbow, side view.

FIG. 8 As above, when welding has been completed.

FIG. 9 The completed elbow, perspective.

The installation 5 (FIG. 1) showing its structure 6, comprises the welding unit 8, the control unit 9, hood 12, with pipe 13 to carry away, fumes.

The unit 9 comprises a display 10 and controls 11.

The welding unit 8 (FIGS. 2 and 3) comprises protruding weld points 30 and 32, here called external) extending along a geometrical welding axis XX and respectively worked by a dynamically operative cylinder 34 with piston 35, and by a dynamically operative cylinder 37 with piston 36.

Said weld points 30 and 32 are connected to a first wire leading to a source of electric current by elastic contacts 31, 33.

A welding head 40 is placed between the external points 30 and 32, said head, in contraposition to said external points, carrying protruding weld points 41 and 42 here called the internal points, also extending along the geometrical welding axis XX.

Said welding head 40 is fixed to an arched bar 44, the radius and dimensions of which correspond to the internal radius and dimensions of the pair 18 of elbow halves to be welded, said bar having a base 47 fixed to a support 46 by means of a pin 45 and being connected by the elastic contact 48 to the second wire leading to the source of electric current.

Above and below the welding head 40 are shaped guide rollers, 50 and 57 respectively, turning freely on geometrical axes parallel to the welding axis XX.

The upper roller 50 is supported by the upper fork 51 facing downward and joined uppermost to the position governor 53, this in turn being fixed to the piston 56 of the dynamic cylinder 55.

The lower roller 57 is supported by the upward facing fork 58; this presents an opposing lower fork 59 facing downward and having, at its two ends, small wheels 60 opposed to the cams 66 and 68 mounted on a mechanical shaft 61 which also carries pulleys 63 and 64 supported by the body 62 forming part of the structure 6 of the installation 5.

The pulleys 63 and 64 are linked by belts 74 and 76 to smaller pulleys 70 and 72 fixed to the shaft 82 of the electric motor 80 placed at the base of the installation.

FIGS. 4 and 5 show how association is made between the pair 18 of elbow halves 15 and 16 and the assembly head 90 whose base presents toothing 94.

In said head 90 is a circular groove 91 into which the first end 18¹ of said pair 18 of elbow halves is fitted.

Insertion of said first end is stabilized by a pair of springs 92 and 93. The plate 95 is fixed to the shaft 61 by bushings 105 and 106 (FIGS. 2, 3) and by arms 102, 103, said plate being guided in its movement by an arch 96 with channel 97, by an arch 98 with channel 99, and by pins 100.

As seen in FIGS. 2 and 3, in the plate 95 is a large hole 108 said hole presenting external connecting means 109, and internal connecting means 110 and 112.

As shown in FIG. 6, the second end 18² of the pair of elbow halves, left free after the first end 18¹ has been inserted into the assembly head 90, is fitted into said hole 108.

At the start of the production cycle, the plate 95 stands substantially vertical (FIG. 6) while the toothing 94 on the assembly head 90 fits in between the ribbing 116 (FIG. 6) in the bracket 114, the height of which can be adjusted by means of the screws 117.

The production cycle comprises two stages: spot welding and continuous welding.

On starting up the cycle by pressing the pedal 14 (FIG. 1), the electric motor 80 moves the shaft 61 and rotates the mobile plate 95. The pair 18 of elbow halves is drawn by said plate 95 (FIGS. 6, 7) over an arc substantially corresponding to the length of said pair 18. In the first section of rotation by the mobile plate 95, the cams 66 and 68 mounted on shaft 61, raise the fork 58 and therefore the roller 57, while the piston 56 in the dynamic cylinder 55 (Figure) lowers the fork 51 and therefore the roller 50 (FIG. 7) ensuring the correct position of the pair 18 of elbow halves in relation both to the external protruding weld points 30, 32 and to the opposing internal protruding weld points 41 and 42 during the entire rotation of said mobile plate 95 (see also FIG. 3).

While translation of the pair 18 of elbow halves is proceeding, at programmed intervals the electric welding circuit (FIGS. 2 and 3) comprising electric contact 48 at the base of the arched bar 44, of the head 40 with internal projecting weld points 41, 42, and electric contacts 31, 33 with the external projecting weld points 30, 32.

Closure of said electric circuit determines execution of spot welds 24 at intervals (FIG. 7) so stabilizing the longitudinal elbow halves 15, 16 forming the pair 18.

On completion of the spot weld stage, the machine stops in the position shown in FIG. 7.

The assembly head 90 is then removed from the pair 18 of welded halves and the stage of substantially continuous welding (FIG. 8) is begun by once again pressing the pedal 14.

This stage comprises reverse rotation of the electric motor 80 and therefore reversal of the plate 95 and of the pair 18 of welded elbow halves.

At the same time the electric circuit closes to determine substantially continuous welding, internal 26 and external 27, so transforming the pair 18 into an elbow 22.

Also at the same time reverse rotation of the cams 66, 68 has lowered the roller 57, while the dynamic cylinder 55 has raised the roller 50 permitting easy removal of the elbow 22.

FIG. 9 illustrates said elbow 22 to show up the continuous welds, external 26 and internal 27.

1. Installation for making elbows (22) for draining rainwater, characterized in that the elbows (22) are made by executing a series of external (26) and internal (27) spot welds on the superimposed longitudinal-edges of a pair (18) of assembled elbow halves (15, 16).

2. Installation for making elbows (22) as in claim 1, characterized in that the pair (18) of elbow halves (15,16) is assembled by insertion of a first end (18¹) into the circular groove (91), provided with elastic means of attachment (92,93), of a head (90) here called an assembly head.

3. Installation for making elbows (22) as in claim 1, characterized in that the external (26) and internal (27) welds are made by causing the assembled pair (18) of elbow halves to slide around and along an arched bar (44) of a radius corresponding to that of said pair (18), and of a length corresponding to that of the maximum length of said pair, there being placed at the beginning of said bar (44) a head (40) with two lateral projecting welding points (41, 42) here called internal points, lying along a geometrical welding axis XX transversal to the lengthwise geometrical plane of symmetry of said arched bar (44) and so placed as to maintain contact with the internal surface of said pair (18) of elbow halves at their longitudinal superimposed edges, there being similarly placed along said welding axis XX two lateral projecting welding points (30, 32) here called external points worked by pistons (35, 37) of dynamic cylinders (34, 36), the internal welding points (41, 42) being connected, through the arched bar (44) and elastic contact (48), to the first wire leading to a source of electric current, the external welding points (30, 32) being connected through elastic contacts (31, 33) to the second wire leading to said source of electric current.

4. Installation for making elbows (22) as in claims 1 and 2, characterized in that it comprises a mechanical shaft (61) rotated by an electric motor (80), lying on a geometrical axis YY substantially coinciding with that of the arched bar, said shaft (61) being fixed by two lateral arms (102, 103) to a plate (95) in which is a large hole (108) furnished with means of attachment (109, 110, 112) to receive the second end (18²) of the pair (18) of elbow halves when the assembly head (90), into which the first end (18¹) of said pair has already been inserted, is positioned on a bracket (114) lying substantially on the same horizontal geometrical plane as that on which lies the axis YY of the mechanical shaft (61).

5. Installation for making elbows (22) as in claims 1, 3 and 4, characterized in that also lying substantially on the same vertical geometrical plane as that of the geometrical axis of the mechanical shaft YY and welding axis XX, are the geometrical axes of two guide rollers for the pair (18) of elbow halves (15, 16) to be welded, which rollers can translate on their geometrical planes respectively, the upper roller (50) being worked by the piston (56) of a dynamic cylinder (53) and the lower roller (57) being worked by cams (66, 68) mounted on the mechanical shaft (61).

6. Installation for-making elbows (22) as in claims 1-5, characterized in that, having pressed a pedal (14) placed on the front of the installation (5), the first stage of the production cycle begins when the electric motor (80) sets in motion the mechanical shaft (61) determining a sliding movement of the pair (18) of elbow halves towards the rear of the installation, pulled by the plate (95) into which the second end (18²) of said pair (18) of elbow halves is already inserted, and guided by the upper roller (50) and the lower roller (57) which have simultaneously approached said pair (18) of elbow halves, an electronic governor (9) closing the electric circuit by moving the external welding projections (30, 32) towards the internal welding projections (41, 42) at programmed intervals to stabilize by spot welding the pair (18) of elbow halves, the assembly head (90) being removed by hand from said pair (18) of elbow halves when their sliding movement along the arched bar (44) has terminated, further pressure applied to the pedal (14) then initiating the second substantially continuous welding stage comprising movement in reverse of the plate (95) and therefore of the stabilized pair (18) of elbow halves, closure of the electric circuit by movement of the external welding projections (30, 32) towards the internal welding projections (41, 42) and, on completion of the cycle, detachment of the upper roller (50) and of the lower roller (57) from the elbow (22) so permitting it to be removed.

7. Installation for making elbows (22) as in claim 1, characterized in that a control unit can determine as required the length of the arc movement made by the mobile plate according to the length of the elbow to be welded.

8. Process for making elbows (22) for draining rainwater as explained in claims 1 to 7.
